(19) United States
(12) Patent Application Publication
(10) Pub. No.: US 2022/0026248 A1
(43) Pub. Date: Jan. 27, 2022

(54) WET GAS FLOW METER BASED ON RESONANT DENSITY AND DIFFERENTIAL PRESSURE MEASUREMENT

(71) Applicant: Sea Pioneers Technologies Co., Ltd., Wuxi (CN)

(72) Inventors: Bin XU, Wuxi (CN); Jige CHEN, Wuxi (CN)

(21) Appl. No.: 17/497,863

(22) Filed: Oct. 8, 2021

Related U.S. Application Data
(63) Continuation-in-part of application No. PCT/CN2019/083819, filed on Apr. 23, 2019.

(30) Foreign Application Priority Data
Apr. 11, 2019 (CN) 201910290355.1

(51) Int. Cl. G01F 1/36; G01F 1/40; G01F 1/58; G01N 9/00

(52) U.S. Cl. CPC G01F 1/363; G01N 9/002; G01F 1/58; G01F 1/40

(57) ABSTRACT

A wet gas flow meter includes an input pipe section; a vibration measurement pipe; an output pipe section; a differential pressure sensor; a pressure sensor; a transducer; and a temperature sensor. The input pipe section, the vibration measurement pipe, and the output pipe section are connected sequentially one by one. The input pipe section includes a first pressure tap, and the output pipe section include a second pressure tap; the differential pressure sensor communicates with the input pipe section and the output pipe section via the first pressure tap and the second pressure tap, respectively. The pressure sensor communicates with the input pipe section and/or the output pipe section via the first pressure tap and/or the second pressure tap, respectively. The transducer is disposed on the vibration measurement pipe. The temperature sensor is disposed on the vibration measurement pipe and/or the input pipe section and/or the output pipe section.

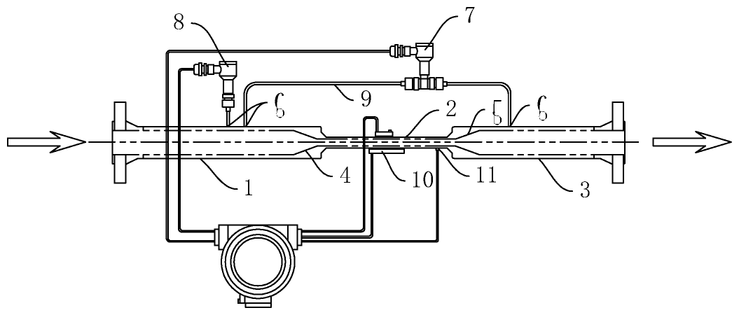

### CROSS-REFERENCE TO RELATED APPLICATIONS

This application is a continuation-in-part of International Patent Application No. PCT/CN2019/083819 with an international filing date of Apr. 23, 2019, designating the United States, now pending, and further claims foreign priority benefits to Chinese Patent Application No. 201910290355.1 filed Apr. 11, 2019. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to the field of wet gas flow meters, and more particularly to a wet gas flow meter based on resonant density and differential pressure measurement.

Wet gas is any gas with a small amount of liquid present, and widely exists in industries such as oil and gas exploration, refining and chemical industry, energy and power, etc. Wet steam and wet natural gas are two typical examples of wet gas. The wet steam is often accompanied by phase change, which is significantly affected by heat transfer process; the wet natural gas has almost no phase change and the change of temperature only influences the medium density.

There are two kinds of wet gas measurement methods. The first method is to measure the wet gas by traditional single-phase gas flow meters. Because the gas contains a small amount of liquid, the indicating values of most gas flow meters are much higher than actual values, and it is necessary to establish a mathematical model to correct the humidity. The second method is to measure the wet gas by a wet gas flow meter adopting the modern new technologies, including microwave, ultrasound, cross-correlation, tracing and process tomography, etc. However, the modern measurement technologies are currently in the stage of field test or laboratory R&D.

### SUMMARY

One object of the disclosure is to provide a wet gas flow meter, which can measure the wet gas based on the resonant density measurement and differential pressure flow measurement.

The disclosure provides a wet gas flow meter based on resonant density and differential pressure measurement. The wet gas flow meter comprises an input pipe section; a vibration measurement pipe; an output pipe section; a differential pressure sensor; a pressure sensor; a transducer; and a temperature sensor. The input pipe section, the vibration measurement pipe, and the output pipe section are connected sequentially one by one; the input pipe section comprises a first pressure tap, and the output pipe section comprise a second pressure tap; the differential pressure sensor communicates with the input pipe section and the output pipe section via the first pressure tap and the second pressure tap, respectively; the pressure sensor communicates with the input pipe section and/or the output pipe section via the first pressure tap and/or the second pressure tap, respectively; the transducer is disposed on the vibration measurement pipe; and the temperature sensor is disposed on the vibration measurement pipe and/or the input pipe section and/or the output pipe section.

Based on the above technical scheme, the differential pressure flow is measured by the differential pressure sensor communicating with the input pipe section and the output pipe section, and the resonant density measurement is implemented by the vibration measurement pipe and the transducer, thus achieving the dynamic combination of the resonant density meter and the differential pressure flow meter. The corresponding data detected by the relevant transducers are fed back to a flow computer, and the results are obtained through comprehensive calculation; all media pass through the vibration measurement pipe so that the two-phase mixed media can all be measured, avoiding the problem of representativeness for sampling measurement. The position where the mixed density is measured is the position where the flow is measured, which avoids the inaccuracy of the gas density caused by pressure changes in different places, leading to inaccurate phase fractions. According to the existing methods, multiple measuring devices are connected in series, that is, two units of vibration measurement pipe are connected to the differential pressure flow meter in series, which will bring a problem, i.e. the mixture density measured at the vibration measurement pipe cannot represent the mixture density at the differential pressure flow meter. Because one of the inherent characteristics of a differential pressure flow meter is pressure change, the pressure change will bring about changes in gas density. The mixture density at the throttle is also different from the mixture density at other parts. Although it has been corrected or compensated and is basically a representative value, its correction and compensation is affected by multiple parameters, which is complicated and inaccurate, and the inaccuracy of the mixture density caused by them will not only affect the measurement of the total flow, but also affect the phase fraction measurement; by integrating the vibration measurement pipe with the differential pressure flow meter in the same device, the detection accuracy can be improved greatly.

In a class of this embodiment, a diameter of a first joint between the input pipe section and the vibration measurement pipe dwindles in a direction from the input pipe section to the vibration measurement pipe.

In a class of this embodiment, the first joint comprises a first inclined plane formed by an outer wall of the input pipe section contracting inwards and towards the vibration measurement pipe.

In a class of this embodiment, a diameter of a second joint between the vibration measurement pipe and the output pipe section increases in a direction from the vibration measurement pipe to the output pipe section.

In a class of this embodiment, the second joint comprises a second inclined plane which is inclined upwards from an inner wall to an outer wall of the output pipe section.

By adopting the above technical solution, the diameter of the first joint between the input pipe section and the vibration measurement pipe dwindles along the flow direction of the medium, and the diameter of the second joint between the vibration measurement pipe and the output pipe section increases. Thus, a throttling component is formed to achieve the function of throttling and acceleration; accompanying with the differential pressure sensor, a throttling differential pressure type flow meter is formed; the diameter contraction and expansion of the measurement pipe allows the vibration measurement pipe to simultaneously possess two functions of density measurement based on the resonance principle and flow measurement based on the throttling differential pressure principle; in addition, the first inclined plane formed by the diameter contraction and the second inclined plane formed by the diameter expansion can minimize the generation of disturbing eddy currents in the throttled pipe section as much as possible.

In a class of this embodiment, a pipe diameter of the input pipe section and a pipe diameter of the pipe diameter of the output pipe section are both larger than a pipe diameter of the vibration measurement pipe.

By adopting the above technical solution, the medium input to the input pipe section can have a larger inflow volume, and when entering the vibration measurement pipe, the medium will pass through the diameter contraction position, to facilitate to form the function of throttling and acceleration, so that the medium that enters the vibration measurement pipe has a certain flow velocity for subsequent measurement; after passing through the diameter-expanding position, the medium enters the output pipe section, to reduce the flow velocity.

In a class of this embodiment, a wall thickness of the input pipe section and a wall thickness of the output pipe section are greater than a wall thickness of the vibration measurement pipe.

Since the vibration measurement pipe needs to be driven to form a vibration to complete the detection, the wall thickness of the vibration measurement pipe should be smaller than the wall thickness of the input pipe section and the output pipe section; in addition, it can also effectively prevent the input pipe section and output pipe section from vibrating and causing interference.

In a class of this embodiment, the first pressure tap is disposed on the input pipe section in advance of the first joint.

In a class of this embodiment, the second pressure tap is disposed on the output pipe section following the second joint.

By adopting the above technical solution, the pressure tap is disposed so as to measure the differential pressure between the input pipe section and the output pipe section. If the pressure tap is disposed after diameter contraction or before diameter expansion, the diameter contraction and expansion will have the effect of throttling and acceleration. Therefore, the differential pressure between the input pipe section and the output pipe cannot be accurately obtained, which will affect the measurement accuracy.

In a class of this embodiment, the differential pressure sensor communicates with the first pressure tap and the second pressure tap through a pressure transmission pipe.

By adopting the above technical solution, the pressures that need to be detected on the input pipe section and the output pipe section are transmitted to the differential pressure sensor through the pressure transmission pipe, thereby achieving the detection of differential pressure between the input pipe section and the output pipe section.

The transducer is positioned in the middle of the vibration measurement pipe.

By adopting the above technical solution, the middle position of the vibration measurement pipe can avoid the influence generated by the input pipe section and the output pipe section as much as possible. That is, during the vibration of the vibration measurement pipe, the input pipe section and the output pipe section are also affected to produce weak vibration that affects the detection of the transducer.

The following advantages are associated with the wet gas flow meter of the disclosure: the measurement of the wet gas is completed through calculations based on the resonant density measurement and differential pressure flow measurement, which is suitable for practical needs in terms of the performance and cost.

### BRIEF DESCRIPTION OF THE DRAWINGS

The disclosure is described hereinbelow with reference to accompanying drawings, in which the sole FIGURE is a schematic view of a wet gas flow meter based on resonant density and differential pressure measurement.

In the drawings, the following reference numbers are used: 1. Input pipe section; 2. Vibration measurement pipe; 3. Output pipe section; 4. First inclined plane; 5. Second inclined plane; 6. Pressure tap; 7. Differential pressure sensor; 8. Pressure sensor; 9. Pressure transmission pipe; 10. Transducer; 11. Temperature sensor.

### DETAILED DESCRIPTION

To further illustrate, embodiments detailing a wet gas flow meter are described below. It should be noted that the following embodiments are intended to describe and not to limit the disclosure.

Referring to the sole FIGURE, the disclosure provides a wet gas flow meter based on resonant density and differential pressure measurement disclosed. A gas-liquid two-phase medium flows in the wet gas flow meter, and the related parameters of the gas-liquid two-phase medium are detected, comprising total flow and phase fraction (gas fraction+liquid fraction=1); that is, by obtaining the two parameters and through related calculations, accurate measurement data of wet gas are available.

The wet gas flow meter in the disclosure comprises an input pipe section 1, a vibration measurement pipe 2 and an output pipe section 3 that are connected sequentially one by one. The three pipe sections form an integrated structure. Optionally, the three pipe sections are fixedly connected to each other by the existing fixing parts such as flange interfaces, etc. In addition, corresponding sealing rings can be disposed to avoid leakage.

To allow the vibration measurement pipe 2 to simultaneously possess two functions of density measurement based on the resonance principle and flow measurement based on the throttling differential pressure principle, the pipe diameter of the input pipe section 1 and the pipe diameter of the output pipe section 3 are both larger than the pipe diameter of the vibration measurement pipe 2, so that the diameter contraction is achieved on the joint between the input pipe section 1 and the vibration measurement pipe 2; specifically, a first inclined plane 4 that is inclined from the outer wall toward the inner wall along the medium flow direction is provided on the input pipe section 1. The diameter expansion is achieved on the joint between the vibration measurement pipe 2 and the output pipe section 3; specifically, a second inclined plane 5 that is inclined from the inner wall toward the outer wall of the pipe along the medium flow direction is provided on the output pipe section. The diameter contraction and expansion makes the input pipe section 1, the vibration measurement pipe 2 and the output pipe section 3 form at least two throttling components, to achieve the function of throttling and acceleration. The first inclined plane formed by the diameter contraction and the second inclined plane formed by the diameter expansion can minimize the generation of disturbing eddy currents in the throttled pipe section as much as possible.

The wall thickness of the input pipe section 1 and the output pipe section 3 is greater than the wall thickness of the vibration measurement pipe 2. The wall thickness of both the input pipe section 1 and the output pipe section 3 are thicker, while the wall thickness of the vibration measurement pipe 2 is thinner and the wall has a certain elasticity, to facilitate the vibrating of the vibration measurement pipe 2 by driving. The input tube section 1 and the output tube section 3 will not be driven to vibrate due to a greater wall thickness. Furthermore, the wall thickness disposed on the input pipe section 1 and the diameter-reducing part as well as on the output pipe section 3 and the diameter-expanding part is greater, to avoid interference as much as possible.

A pressure tap 6 is disposed on both the input pipe section 1 and the output pipe section 3, and the pressure tap 6 is connected to a differential pressure sensor 7. The differential pressure sensor 7 and the pressure tap 6 are both connected through a pressure transmission pipe 9. The pressure tap 6 on the input pipe section 1 is positioned on the pipe section of the input pipe section 1 before the diameter contraction is performed; the pressure tap 6 on the output pipe section 3 is positioned on the pipe section of the output pipe section 3 after the diameter expansion is performed.

The pressure tap 6 on the input pipe section 1 and/or the output pipe section 3 is further connected to a pressure sensor 8 for measuring the absolute pressure of the pipe section; the pressure tap 6 that is connected to the pressure sensor 8 can be a pressure tap 6 that is connected to the differential pressure sensor 7, or a new pressure tap 6 on the input pipe section 1 and/or the output pipe section 3. In this embodiment, the new pressure tap 6 on the input pipe section 1 and/or the output pipe section 3 is preferably adopted. In the measurement process, the absolute pressure on the input pipe section 1 can be measured, or the absolute pressure on the output pipe section 3 can be measured, or the absolute pressures on the input pipe section 1 and the output pipe section 3 can be measured simultaneously. In this embodiment, the absolute pressure measured on the input pipe section 1 is preferably adopted, so a new pressure tap 6 is opened on the input pipe section 1 and connected to the pressure sensor 8 to complete the detection of the absolute pressure.

A transducer 10 is disposed on the vibration measurement pipe 2. The transducer 10 is an electro-mechanical energy transducer, which can be an electromagnetic coil, a piezoelectric, etc. for exciting and receiving vibrations. In one embodiment, the transducer 10 comprises, but is not limited to, an electromagnetic coil. The electromagnetic coil is mounted on a corresponding fixed base, and a current is applied to the electromagnetic coil, so that the electromagnetic coil generates a magnetic field, which interacts with a permanent magnet or soft magnetic component on the vibration measurement pipe 2, to drive the vibration measurement pipe 2 to complete the electro-mechanical energy conversion process. At the receiving end, the permanent magnet is fixed on a vibrating tube, and the electromagnetic coil is fixed on the fixed base. After vibrating, the vibrating tube drives the permanent magnet to move. At this time, the magnetic field of the permanent magnet and the electromagnetic coil move relative to each other. The electromagnetic coil cuts the magnetic line of force to generate an electrical signal related to the vibration signal to complete the mechanical-electrical energy conversion. In one embodiment, the piezoelectric transducer 10 takes advantage of the characteristics of piezoelectric materials. When a voltage is applied, the geometric dimensions of the material change, to complete the electro-mechanical energy loop; when a pressure is applied, deformation is generated, and corresponding electrical signal will be generated, to complete the mechanical-electrical energy conversion. The transducer 10 should be provided in a pair, one transducer is configured to drive the vibration measurement pipe 2 and the other transducer is configured to receive the vibration of the vibration measurement pipe 2. The working mode is as follows: the signal obtained at the receiving end is amplified by an electronic circuit, and the transducer 10 at the other end is driven by the same phase, to generate resonance.

The transducer 10 is positioned in the middle of the vibration measurement pipe 2; that is, during the vibration of the vibration measurement pipe 2, the input pipe section 1 and the output pipe section 3 are also affected to produce weak vibration that affects the detection of the transducer 10. The middle position of the vibration measurement pipe 2 can avoid the influence generated by the input pipe section 1 and the output pipe section 3 as much as possible.

A temperature sensor 11 is disposed on the vibration measurement pipe 2 and/or the input pipe section 1 and/or the output pipe section 3 for measuring the temperature of the medium. In this embodiment, it is preferable to provide a corresponding temperature sensor 11 on the vibration measurement pipe 2. The temperature sensor 11 adopts a miniature, low-mass device, and its models include but not limited to PT100, PT1000 and other thermistors. The transducer is attached to the wall of the vibration measurement pipe 2, and the signal is connected through a thin wire. The thin wire has a margin to prevent it from being damaged by vibration. The temperature sensor 11 must be provided, which is used to calculate the necessary parameters of the gas density.

The implementation principle of the wet gas flow meter is detailed as follows:

The gas-liquid two-phase medium flows through the input pipe section 1, the vibration measurement pipe 2 and the output pipe section 3 sequentially. The differential pressure flow is measured by the differential pressure sensor 7 communicating with the input pipe section 1 and the output pipe section 3, and the resonant density measurement is implemented by the vibration measurement pipe 2 and the transducer 10. The relevant parameters are detected through the temperature sensor 11 and the pressure sensor 8; the corresponding data detected by all relevant transducers are fed back to a flow computer, and the results can be obtained through comprehensive calculation. The total flow of the two-phase flow is calculated according to the following formula:

$${q}_{v} = \frac{C ɛ}{\sqrt{1 - {β}^{4}}} \frac{π}{4} {d}^{2} \sqrt{\frac{2 Δ p}{{ρ}_{1}}}$$

Where, qv is the volume flow; C is the outflow coefficient; ε is the expansibility coefficient; β is the diameter ratio, β=d/D, d is the diameter of the throttle component opening, D is the inner diameter of pipe; ρ₁ is the measured fluid density; Δp is the differential pressure.

According to the formula, after determining the actual size of the wet gas flow meter, the relevant parameters of the flow formula have been determined.

The expansibility coefficient is related to the medium. For a gas-liquid two-phase flow, the gas-liquid composition of the medium is changed, and the expansibility coefficient is objectively changed, which can be obtained through the compositions of the medium. Because the liquid phase can be considered incompressible and the expansibility coefficient is 1, the expansibility coefficient=Gas-phase expansibility coefficient *(1−liquid fraction)+liquid fraction; the gas-phase expansibility coefficient is the physical characteristic of a gas-phase substance. The total expansibility coefficient of a two-phase flow is calculated by a simple algebraic operation and is related to the liquid fraction.

For gas-liquid two-phase media, through density measurement, the compositions of each phase of the gas and liquid can be determined. After simplification, the two parameters required to obtain in the flow formula are the mixture density and the differential pressure, respectively; both the mixture density and the differential pressure can be obtained through the wet gas flow meter of this application. Thus, the total flow of the wet gas can be measured; the respective flows of the gas and liquid phases are calculated by the following formula: total liquid volume=total flow*liquid fraction; total gas volume=total flow*(1-liquid fraction).

The measurement of liquid fraction is based on the measurement of the mixture density and gas density. The two parameters are both related to temperature and pressure. The result of mixture density affects both the measurements of phase fraction measurement and total flow. The mixture density is used in the relevant formula. The mixture density of the flow part is the density ρ₁ of the measured fluid. The calculation method for the phase fraction part is as follows:

Firstly, the gas density needs to be obtained. According to the gas state equation, PV=εnRT, the gas density ρ is proportional to the pressure P and inversely proportional to the temperature T. After calibrating the density at a state point (pressure, temperature), the gas density of other conditions (pressure and density in different states) can be measured, namely:

$$\frac{{ρ}_{1}}{{ρ}_{2}} = \frac{{P}_{1} * {T}_{2}}{{P}_{2} * {T}_{1}}$$

According to the above formula, the pressure and temperature must be measured, which are the key variables to obtain the gas density. That is, the density ρ_{g1} in the calibrated state is obtained, and then the gas density ρ_{g2} is calculated through temperature and pressure values, and the mixed density ρₘᵢₓ of the gas-liquid two-phase medium is obtained by measuring the resonance frequency of the vibrating tube 2. After simple algebraic calculations, the phase fraction can be obtained. If the volumetric liquid fraction η is used, the liquid is not compressible, and the liquid density is ρ_{L}, then:

ρₘᵢₓ=(1−η)*ρ_{g2}+η*ρ_{L}

After simplification,

$$η = \frac{{ρ}_{mix} - {ρ}_{g 2}}{{ρ}_{L} - {ρ}_{g 2}}$$

According to the volume flow formula in the flow formula, under the working conditions:

The total liquid volume=qv*η

The total gas volume=qv*(1−η)

Thus, the calculations of the two-phase flow are completed.

It will be obvious to those skilled in the art that changes and modifications may be made, and therefore, the aim in the appended claims is to cover all such changes and modifications.

The invention claimed is:

1. A wet gas flow meter, comprising:
an input pipe section;
a vibration measurement pipe;
an output pipe section;
a differential pressure sensor;
a pressure sensor;
a transducer; and
a temperature sensor;
wherein:
the input pipe section, the vibration measurement pipe, and the output pipe section are connected sequentially one by one;
the input pipe section comprises a first pressure tap, and the output pipe section comprise a second pressure tap; the differential pressure sensor communicates with the input pipe section and the output pipe section via the first pressure tap and the second pressure tap, respectively;
the pressure sensor communicates with the input pipe section and/or the output pipe section via the first pressure tap and/or the second pressure tap, respectively;
the transducer is disposed on the vibration measurement pipe; and
the temperature sensor is disposed on the vibration measurement pipe and/or the input pipe section and/or the output pipe section.

2. The wet gas flow meter of claim 1, wherein a diameter of a first joint between the input pipe section and the vibration measurement pipe dwindles in a direction from the input pipe section to the vibration measurement pipe.

3. The wet gas flow meter of claim 2, wherein the first joint comprises a first inclined plane formed by an outer wall of the input pipe section contracting inwards and towards the vibration measurement pipe.

4. The wet gas flow meter of claim 1, wherein a diameter of a second joint between the vibration measurement pipe and the output pipe section increases in a direction from the vibration measurement pipe to the output pipe section.

5. The wet gas flow meter of claim 4, wherein the second joint comprises a second inclined plane which is inclined upwards from an inner wall to an outer wall of the output pipe section.

6. The wet gas flow meter of claim 1, wherein a pipe diameter of the input pipe section and a pipe diameter of the pipe diameter of the output pipe section are both larger than a pipe diameter of the vibration measurement pipe.

7. The wet gas flow meter of claim 3, wherein a pipe diameter of the input pipe section and a pipe diameter of the pipe diameter of the output pipe section are both larger than a pipe diameter of the vibration measurement pipe.

8. The wet gas flow meter of claim 5, wherein a pipe diameter of the input pipe section and a pipe diameter of the pipe diameter of the output pipe section are both larger than a pipe diameter of the vibration measurement pipe.

9. The wet gas flow meter of claim 1, wherein a wall thickness of the input pipe section and a wall thickness of the output pipe section are greater than a wall thickness of the vibration measurement pipe.

10. The wet gas flow meter of claim 3, wherein a wall thickness of the input pipe section and a wall thickness of the output pipe section are greater than a wall thickness of the vibration measurement pipe.

11. The wet gas flow meter of claim 5, wherein a wall thickness of the input pipe section and a wall thickness of the output pipe section are greater than a wall thickness of the vibration measurement pipe.

12. The wet gas flow meter of claim 1, wherein the first pressure tap is disposed on the input pipe section in advance of the first joint.

13. The wet gas flow meter of claim 3, wherein the first pressure tap is disposed on the input pipe section in advance of the first joint.

14. The wet gas flow meter of claim 5, wherein the first pressure tap is disposed on the input pipe section in advance of the first joint.

15. The wet gas flow meter of claim 1, wherein the second pressure tap is disposed on the output pipe section following the second joint.

16. The wet gas flow meter of claim 3, wherein the second pressure tap is disposed on the output pipe section following the second joint.

17. The wet gas flow meter of claim 5, wherein the second pressure tap is disposed on the output pipe section following the second joint.

18. The wet gas flow meter of claim 1, wherein the differential pressure sensor communicates with the first pressure tap and the second pressure tap through a pressure transmission pipe.

19. The wet gas flow meter of claim 3, wherein the differential pressure sensor communicates with the first pressure tap and the second pressure tap through a pressure transmission pipe.

20. The wet gas flow meter of claim 5, wherein the differential pressure sensor communicates with the first pressure tap and the second pressure tap through a pressure transmission pipe.
